(19) United States
(12) Patent Application Publication
(10) Pub. No.: US 2003/0035347 A1
(43) Pub. Date: Feb. 20, 2003

(54) Case, strap and timepiece

(76) Inventor: Koichi Yokosuka, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/213,259

(22) Filed: Aug. 6, 2002

(30) Foreign Application Priority Data
Aug. 20, 2001 (JP) 2001-249444

(51) Int. Cl. A44C 5/00; G04B 37/00

(52) U.S. Cl. 368/281

(57) ABSTRACT

To provide a case, a strap and a timepiece for preventing rotation of the strap. A roof rear face recessed portion is formed at a roof rear face of a strap attaching portion of a timepiece case. A strap is formed with a rotation stop projection at a rotation stop face of the strap opposed to the roof rear face recessed portion. The case, the strap and the timepiece having a strap rotation stop structure by respectively engaging the recessed portion and the projected portion.

### BACKGROUND OF THE INVENTION

1. Field of the Invention

The present invention relates to a case, a strap and a timepiece combined with the case and the strap.

2. Description of the Prior Art

An explanation will be given of a conventional case, a conventional strap and a conventional timepiece in reference to the drawings. FIG. 3 is a sectional view in a state of a timepiece attaching a strap to a case. FIG. 4 is a sectional view of the case and the strap.

A conventional case 5 is provided with a strap attaching portion roof 52 for attaching a strap 6. The strap attaching portion roof 52 is provided with a strap attaching portion 51 constituting a space for bringing a portion of the strap 6 to a side of a caseback (hereinafter, referred to as ‘bottom side’). Further, the strap attaching portion 51 is opened with a spring rod pin hole 55 for inserting a spring rod 3.

Further, the conventional strap 6 is provided with a spring rod hole 65 for inserting the spring rod 3 in a width direction of the strap. A periphery of the spring rod hole 65 is provided with a strap inserting face 62 for inserting to the strap attaching portion 51. Further, the strap inserting portion 62 is provided with a stepped difference such that the strap 6 is prevented from rotating when the strap 6 is attached to the case 5. Further, the strap 6 is provided with a rotation stop tongue 67 which is brought into contact also with a case back 57 to thereby prevent rotation.

Further, the conventional timepiece is assembled with the strap 6 and the case 5 by inserting the spring rod 3 into the spring rod hole 65 of the strap 6 and inserting a front end of the spring rod 3 into the spring rod pin hole 55 of the case 5.

The conventional timepiece poses a problem that when the strap attaching portion is applied with a stress for rotating the strap in a direction of a rear face thereof, a large gap is produced at a portion of coupling the case and the strap, or the strap is rotated.

Further, in order to prevent the rotation, there is a method of setting positions of a spring rod pin hole of a case and a spring rod hole of a strap and attaching the case and the strap by a spring rod 3 constituting a connecting member in a shaft-like shape penetrating the case and the strap such that the strap is pressed to attach to the case as much as possible by utilizing elasticity of the strap. However, the method poses a problem that repulsive force produced by pressing the strap to the case is always operated to the spring rod pin hole for holding the shaft-like connecting member of the case shown in FIG. 4 respectively in a horizontal direction f1 and a vertical direction f2 and therefore, the case is deformed by the repulsive force. When the repulsive force is strong, crack can be brought about. When a shape of a surrounding of the spring rod pin hole 55 is deformed, the spring rod cannot be held and the strap is detached from the case.

### SUMMARY OF THE INVENTION

According to a timepiece of the invention, in a timepiece including a case formed with a strap attaching portion roof at a strap attaching portion thereof, a strap attached to the case, and a spring rod holding the strap to the case by penetrating the case and the strap, the case includes a roof rear face recessed portion formed by recessing a portion of the roof rear face of the strap attaching portion, the strap includes a rotation stop projection at a rotation stop face of the strap and prevents rotation of the strap by engaging the rotation stop projection and the roof rear face recessed portion.

The roof rear face recessed portion is formed at the roof rear face of the strap attaching portion of the case, the rotation stop projection is formed at the rotation stop face of the strap opposed to the recessed portion and the recessed portion and the projected portion are respectively engaged with each other to thereby stop rotation of the strap in view of its structure.

A band according to the invention includes a rotation stop face provided with a stepped difference from an outer shape thereof in an inner direction and the rotation stop face includes a rotation stop projection extended in a direction of the outer shape.

Further, the band according to the invention further includes a spring rod hole for inserting a connecting member to be attached to other member and the rotation stop projection is disposed upward from the spring rod hole.

A case according to the invention is a case including a strap attaching roof for attaching a strap, and a strap attaching portion for inserting the strap to a rear face of the strap attaching roof and the strap attaching portion includes a roof rear face recessed portion for stopping rotation of the strap.

Further, a timepiece according to the invention includes the strap, the case, and a connecting member for attaching the strap to the case and prevents rotation of the strap by engaging the rotation stop projection and the roof rear face recessed portion of the case with each other when the strap is assembled to the case.

### BRIEF DESCRIPTION OF THE SEVERAL VIEWS OF THE DRAWINGS

A preferred form of the present invention is illustrated in the accompanying drawings in which:

FIG. 1 is a partially sectional view showing a state of attaching a strap according to the invention;

FIG. 2 is a partially sectional view showing portions of a timepiece case and a strap according to the invention corresponding to the invention;

FIG. 3 is a partially sectional view showing a state of attaching a conventional strap;

FIG. 4 is a partially sectional view showing portions of a conventional timepiece and a conventional strap corresponding to the invention; and

FIG. 5 shows a spring rod of a shaft-like connecting member.

### DETAILED DESCRIPTION OF THE PREFERRED EMBODIMENTS

A roof rear face recessed portion 14 is formed at a roof rear face 13 of a strap attaching portion 11 of a timepiece case 1, a rotation stop projection 24 is formed at a rotation stop face 23 of a strap opposed to the recessed portion, the recessed portion and projected portion are respectively engaged with each other to thereby prevent rotation of the strap, there is extinguished a needs of attaching the band to press to the timepiece case as much as possible by utilizing elasticity of the strap as a method of reducing danger of rotation and therefore, it can be prevented that stresses are operated to the spring rod pin hole 55 for holding the spring rod 3 of a shaft-like connecting member of the timepiece case shown in FIG. 4 always in f1 and f2 directions and by elapse of time, a surrounding of the spring rod pin hole 55 of the timepiece case 5 is deformed by delayed fracture by stress of synthetic resin.

[EXAMPLES]

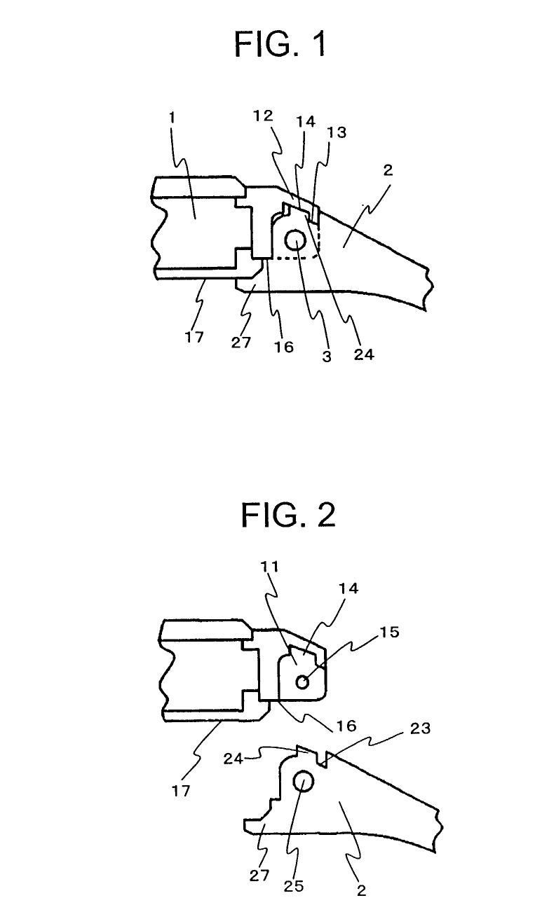

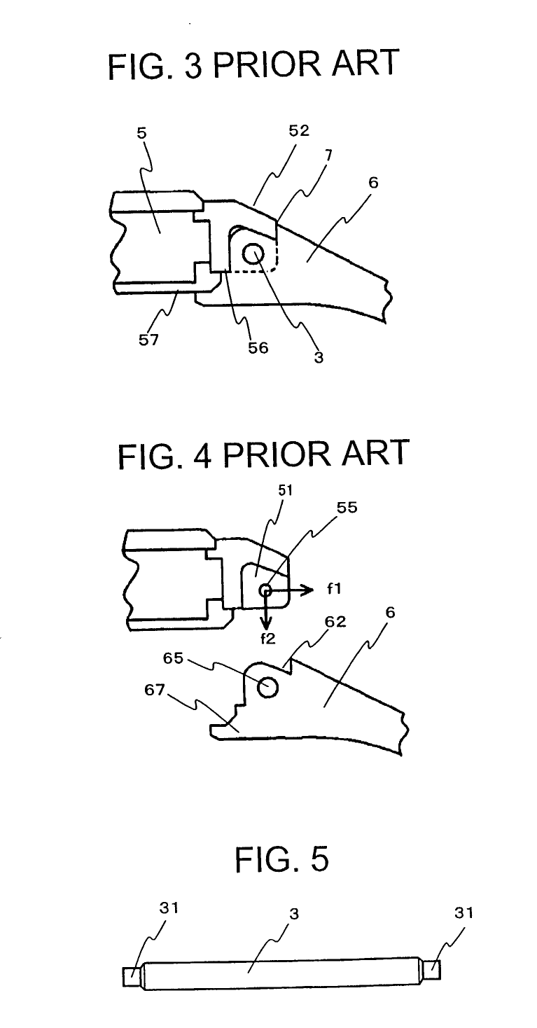

A detailed description will be given of an embodiment of the invention in reference to FIG. 1 and FIG. 2. FIG. 1 is a sectional view showing a state of attaching a strap according to the invention and FIG. 2 is a sectional view of a timepiece case and a strap according to the invention.

According to a specific embodiment, there is formed a roof rear face recessed portion 14 at a roof rear face 13 of a strap attaching portion roof 12 constituting a strap attaching portion 11 of a timepiece case 1 of synthetic resin(generally, ABS resin). Depth of the recessed portion is set to about 2mm. Meanwhile, there is formed a rotation stop projection 24 to be engaged with the roof rear face recessed portion 14 at a position of a rotation stop face 23 of a strap 2 made of polyurethane constituting an elastic material attached to the timepiece case 1, opposed to the roof rear face recessed portion 14 of the timepiece case 1.

The timepiece case 1 and the strap 2 constituted in this way, are attached by penetrating a spring rod hole 25 of the strap 2 and a spring rod pin hole of the timepiece case 1 by using a spring rod 3 constituting a shaft-like connecting member shown in FIG. 5.

According to the strap attached in this way, a rotation stop tongue 27 of the strap 2 is brought into contact with a case back 17 of the timepiece case 1 to thereby prevent rotation and at the same time, there can be resolved the conventional problem that when applied with a stress of rotating the strap 6 in a lower direction, the rotation stop face 63 of the strap 6 is elastically deformed and slid on the roof rear face 53 of the timepiece case 5 to detach from the roof rear face 53, by engaging the roof rear face recessed portion 14 of the timepiece case 1 and the rotation stop projection 24 of the strap 2.

According to the invention, rotation of the strap which is easy to rotate, can firmly be prevented and the gap produced at the portion of coupling the timepiece case and strap can be made to be very small. Further, there can be resolved stresses in the horizontal and the vertical directions generated at the spring rod pin hole for holding the shaft-like connecting member. Thereby, the spring rod pin hole can be prevented from being deformed and the strap can be prevented from being detached. Particularly, although according to a timepiece case using synthetic resin, there is also a case of causing delayed fracture by stress, by resolving the stress, the delayed fracture of the case can also be prevented.

What is claimed is

1. A timepiece comprising:
a timepiece including a case formed with a strap attaching portion roof at a strap attaching portion thereof,
a strap attached to the case, and
a spring rod holding the strap to the case by penetrating the case and the strap;
wherein the case includes a roof rear face recessed portion formed by recessing a portion of the roof rear face of the strap attaching portion; and
wherein the strap includes a rotation stop projection at a rotation stop face of the strap and prevents rotation of the strap by engaging the rotation stop projection and the roof rear face recessed portion.

2. A strap comprising:
a rotation stop face provided with a stepped difference from an outer shape thereof in an inner direction, wherein the rotation stop face includes a rotation stop projection extended in a direction of the outer shape.

3. The strap according to claim 2, further comprising a spring rod hole for inserting a connecting member to be attached to other member;
wherein the rotation stop projection is disposed upward from the spring rod hole.

4. A case comprising:
a strap attaching roof for attaching the strap; and
a strap attaching portion for inserting the strap to a rear face of the strap attaching roof;
wherein the strap attaching portion includes a roof rear face recessed portion for stopping rotation of the strap.

5. A timepiece comprising:
a strap comprising a rotation stop face provided with a stepped difference from an outer shape thereof in an inner direction, wherein the rotation stop face includes a rotation stop projection extended in a direction of the outer shape;
a case comprising a strap attaching roof for attaching the strap; and a strap attaching portion for inserting the strap to a rear face of the strap attaching roof; wherein the strap attaching portion includes a roof rear face recessed portion for stopping rotation of the strap; and a connecting member for attaching the strap to the case;
wherein when the strap is assembled to the case, the rotation stop projection and the roof rear face recessed portion of the case are engaged with each other to thereby prevent rotation of the strap.

6. A timepiece according to claim 5, further comprising a spring rod hole for inserting a connecting member to be attached to other member;
wherein the rotation stop projection is disposed upward from the spring rod hole.
